(19) United States
(12) Patent Application Publication
(10) Pub. No.: US 2009/0189841 A1
(43) Pub. Date: Jul. 30, 2009

(54) Open-loop color management for light emitting diode backlight module

(75) Inventors: Chun-Yu Chen, Tainan County (TW); Tzung-Ren Wang, Tainan County (TW); Lin-Kai Bu, Tainan County (TW)

Correspondence Address: RABIN & Berdo, PC, 1101 14TH STREET, NW, SUITE 500, WASHINGTON, DC, 20005, US

(73) Assignee: HIMAX TECHNOLOGIES LIMITED, Tainan County (TW)

(21) Appl. No.: 12/010,352

(22) Filed: Jan. 24, 2008

(51) Int. Cl. G09G 3/36

(52) U.S. Cl. 345/102

(57) ABSTRACT

An open-loop color management system comprises an indicating means, a controller and an LED driver. The indicating means is for indicating the operation status of the LED backlight module. The controller is for generating a control signal based on the operation status by reference to a look-up table. The LED driver driving the LED backlight module based on the control signal, so the chromaticity of the LED backlight module may be substantially constant over time.

### BACKGROUND OF THE INVENTION

1. Field of the Invention

The invention relates in general to a color management system for light emitting diode (LED) backlight module, and more particularly to an open-loop management system for LED backlight module.

2. Description of the Related Art

Along with increasing development of technology, light emitting diodes (LED) have been wildly used in backlight module of a LCD (Liquid Crystal Display). In the LED backlight module, LEDs with difference colors are used for providing light of different colors, so that the light of different colors is mixed to generate white light. Since the LEDs with different colors have different rates of luminance decay corresponding to the time-of-use of the backlight module and the surrounding temperature, a color management system for LED backlight module is needed for preventing the changing of the chromaticity of the backlight resulting from the different rates of luminance decay of the different colors LEDs.

In a conventional color management system, a close-loop control system is applied for driving the LEDs based on the luminance of red, green, and blue lights generated by the LEDs. However, in the conventional color management system, a large number of color filters, photo detectors, analog-to-digital (A/D) converters, and a micro-controller must be used for the close-loop control system. Therefore, the conventional color management system has the drawback of large component amount and high producing cost. Besides, it is time-consuming to adjust the parameters of the conventional color management system due to the large component amount.

### SUMMARY OF THE INVENTION

The invention is directed to a color management system for light emitting diode (LED) backlight module having less elements number, lower producing and element-adjusting cost in comparison to the conventional color management system.

According to an aspect of the present invention, an open-loop color management system for light emitting diode (LED) backlight module is provided. The open-loop color management system comprises an indicating means, a controller and an LED driver. The indicating means is for indicating the operation status of the LED backlight module. The controller is for generating a control signal based on the operation status by reference to a look-up table. The LED driver drives the LED backlight module based on the control signal, so the chromaticity of the LED backlight module may be substantially constant over time.

The invention will become apparent from the following detailed description of the preferred but non-limiting embodiments. The following description is made with reference to the accompanying drawings.

### BRIEF DESCRIPTION OF THE DRAWINGS

FIG. 1 shows a block diagram of a LCD with the color management system of a first embodiment.

FIG. 2 shows a block diagram of a LCD with the color management system of a second embodiment.

FIG. 3 shows a block diagram of a LCD with the color management system of a third embodiment.

### DETAILED DESCRIPTION OF THE INVENTION

The color management system of the invention is applied in a LCD, which includes a LED backlight module. The color management system of the invention is for controlling the luminance of the LED backlight module by referring to a look-up table in an open-loop control system.

### First Embodiment

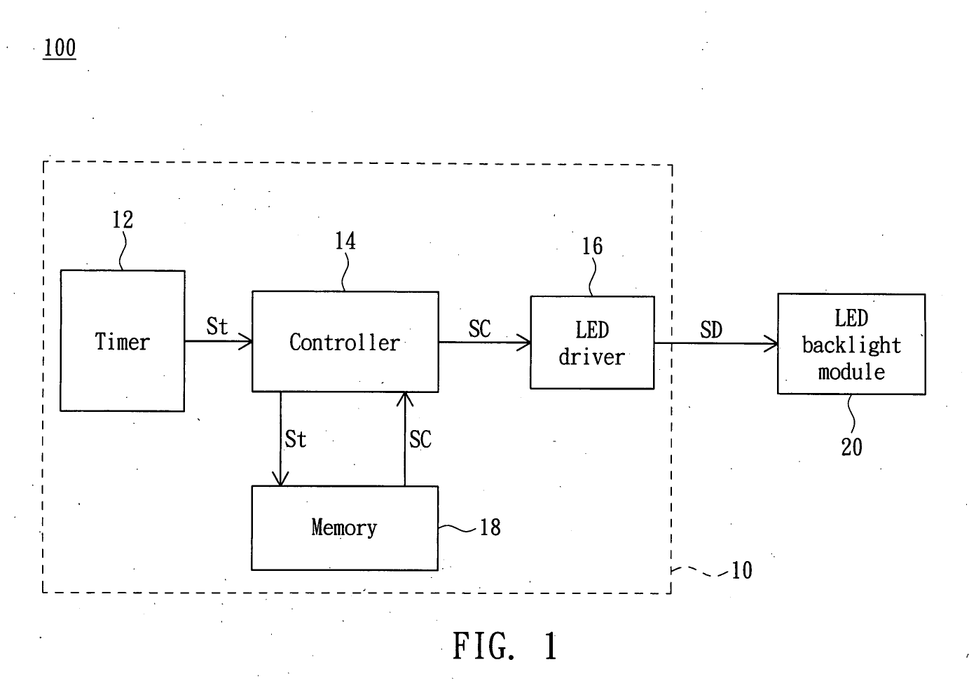

Referring to FIG. 1, a block diagram of a LCD with the color management system of a first embodiment is shown. The LCD 100 includes a LCD panel, a LED backlight module 20 and a color management system 10. The LED backlight module 20 provides backlight, which passes through the LCD panel. The LED backlight module 20 of the embodiment includes LEDs of different colors for emitting light of different color. The light of different colors is mixed to generate the backlight. For example, the LED backlight module 20 includes red LEDs, green LEDs, and blue LEDs (not shown) and the light emitted by the red, the green, and the blue LEDs are mixed to generate white light, which is the backlight.

The color management system 10 drives the red, the green, and the blue LEDs and makes the luminance of the red, the green, and the blue LEDs be substantially constant over time. The substantially constant luminance of the red, the green, and the blue LEDs will make the chromaticity of the backlight substantially constant.

The color management system 10 includes an indicating means, a controller 14, a LED driver 16, and a memory 18. The indicating means is for indicating an operation status of the LED backlight module 20. The operation status is relevant to the change of the luminance of the red, green, and blue LEDs. The indicating means is, for example, a timer 12 for providing a time-of-use signal St to indicate the time-of-use of the LED backlight module 20, which is one of the operation statuses of the LED backlight module 20.

The memory 18 stores a look-up table for mapping the time-of-use signal St to a corresponding control signal SC. The controller 14 is coupled to the timer 12 and the memory 18 for receiving the time-of-use signal St from the timer 12 and providing the time-of-use signal St to the memory 18. Then, the controller 14 can get the corresponding control signal SC from the memory 18 based on the time-of-use signal St of the LED backlight module 20, then send the control signal SC to the LED driver 16. The LED driver 16 provides a driving signal SD to drive the red, the green, and the blue LEDs based on the control signal SC.

The instantaneous luminance of the red, the green, and the blue LEDs decreases with the increase of the time-of-use of the LED backlight module 20. In order to keep the average luminance of the red/green/blue LEDs constant, the color management system 10 adjust the driving signal SD with the increase of the time-of-use of the LED backlight module 20. In the embodiment, the color management system 10 generates the control signal SC according to the time-of-use signal St, and then generates the driving signal SD corresponding to the control signal SC. The values of the control signal SC, which correspond to the characteristics of the red/green/blue LEDs related to the time-of-use of the LED backlight module 20, stored in the look-up table are obtained by experience or experiment, for example.

For example, the driving signal SD may be of the form of a pulse width modulated (PWM) signal. The values of the control signal SC, which may correspond to the voltage level, the frequency, the amplitude or other characteristics of the control signal SC, related to the time-of-use signal St are stored in the look-up table. The value of the control signal SC and the duty cycle of the driving signal SD may increase with the increase of the time-of-use of the LED backlight module 20. With the increased duty cycle of the driving signal SD, the ratio of the time when the red/green/blue LEDs is turned on to the time when the red/green/blue LEDs is turned off is increased. Therefore, the average luminance of the red/green/blue LEDs can be kept constant by increasing the duty cycle of the driving signal SD after the red/green/blue LEDs have been used for a certain time period and the instantaneous luminance of the red/green/blue LEDs has even been already decreased.

As described above, the luminance of the red, green, and blue LEDs are all controlled by the driving signal SD, corresponding to the same control signal SC. In an alternative way, the red, green, and blue LEDs can be controlled by different driving signals corresponding to different control signals, which are generated based on different look-up tables. For example, the memory 18 could store three different look-up tables for mapping the time-of-use signal St to three different control signals for controlling the LED driver 20 to drive the red, green, and the blue LEDs individually Scg and Scb.

The color management system of the embodiment is for controlling the luminance of the different color LEDs in a LED backlight module by refer ring to the corresponding look-up table. By using the driving signal SD which corresponding to the time-of-use signal St, the luminance of the red, the green, and the blue LEDs after being used for a particular time are substantially the same with the original luminance of the red, the green, and the blue LEDs when they were manufactured. Therefore, the chromaticity of the backlight is substantially constant over time.

Furthermore, the color management system of the embodiment has less component number and lower producing cost in comparison to the conventional color management system. Besides, it is much more timesaving to adjust the parameters of the components of the color management system of the invention in comparison to the conventional color management system due to the less component number.

### Second Embodiment

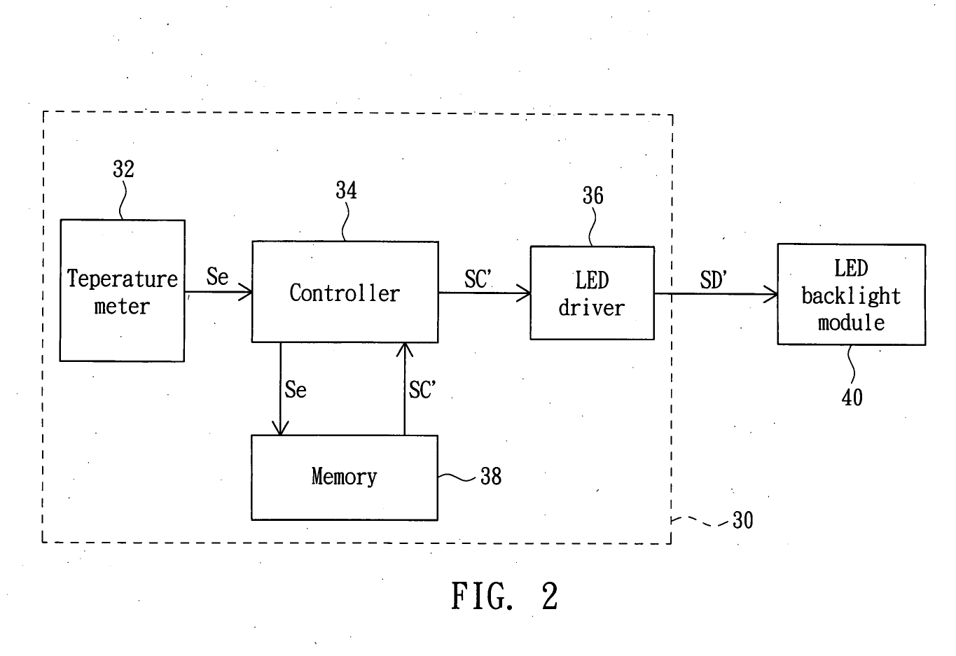

Referring to FIG. 2, a block diagram of a LCD with the color management system of a second embodiment is shown. The color management system 30 of the second embodiment differs from the color management system 10 in the first embodiment in that the indicating means includes a temperature meter 32. The temperature meter 32 is used for obtaining the surrounding temperature of a LED backlight module 40 and for providing a temperature signal Se indicating the surrounding temperature of the LED backlight 40, which is one of the operation statuses of the LED backlight module 40. The memory 38 is different from the memory 18 in the first embodiment in that the memory 38 stores corresponding look-up tables which map the temperature signal Se provided by the temperature meter 32 to a corresponding control signal SC′. The values of the control signal SC′, which corresponding to the characteristics of the red/green/blue LEDs related to different surrounding temperature of the LED backlight module 40, stored in the look-up table are obtained by experience or experiment, for example.

After the temperature signal Se is generated by the temperature meter 32 and is transmitted to the controller 34, the controller 34 receives the control signals SC′ from the memory 38 and then send the control signals SC′ to the LED driver 36. The LED driver 36 provides corresponding driving signals SD′ to drive the red, the green, and the blue LEDs based on the control signals SC′. As a result, the color management system 30 of the embodiment can keep the luminance of the LEDs in a LED backlight module 40 substantially constant and therefore keep the chromaticity of the LED backlight constant. The color management system 30 of the embodiment has the advantages of less elements number needed, lower producing and element-adjusting cost in comparison to the conventional color management system.

In this embodiment, the red, green, and blue LEDs can be also controlled by different driving signals corresponding to different control signals, which are generated based on different look-up tables. The memory 38 can store three different look-up tables for respectively mapping the temperature signal Se to three control signals for controlling the LED driver 36 to drive the red, the green, and the blue LEDs individually.

### Third Embodiment

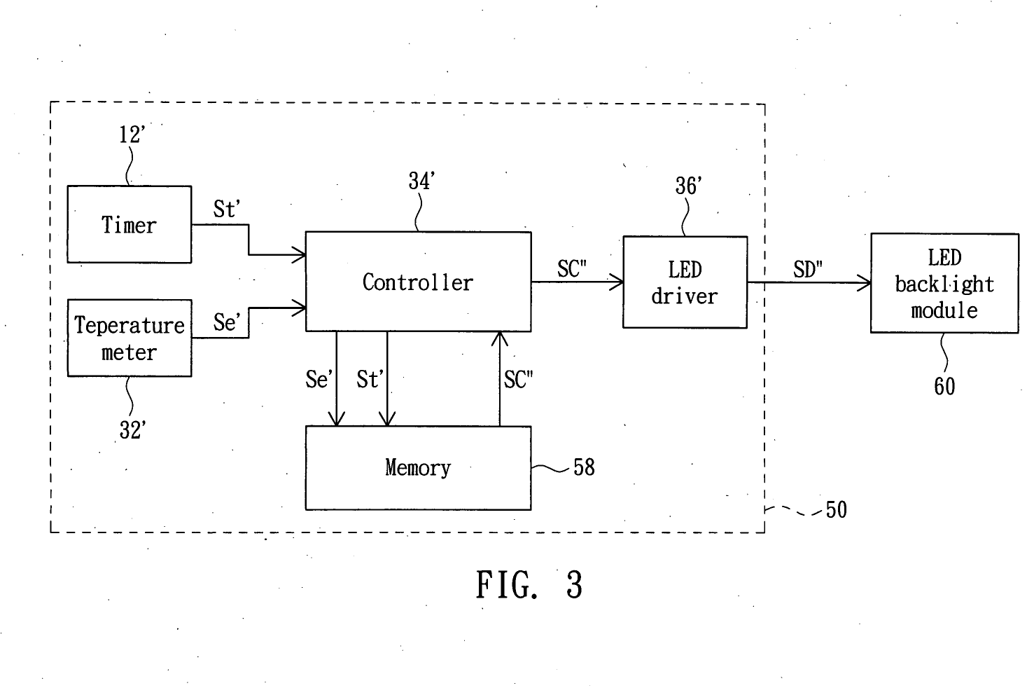

Referring to FIG. 3, a block diagram of a LCD with the color management system of a third embodiment is shown. The color management system 50 of third embodiment differ from the color management system 30 in the second embodiment in that the indicating means includes a timer 12′ and a temperature meter 32′. The operation of the timer 12′ is similar to that of the timer 12 mentioned in the first embodiment for providing a time-of-use signal St′. The operation of the temperature meter 32′ is similar to that of the temperature meter 32 mentioned in the second embodiment for providing a temperature signal Se′. The memory 58 is different from the memory 18 and 38 in the first and the second embodiment respectively in that the memory 58 stores 2-dimensional look-up tables for mapping the time-of-use signal St′ and the temperature signal Se′ to the control signals SC″. The values of the control signal SC″ stored in the look-up table are obtained by experience or experiment, for example.

The controller 34′ receives the control signal SC″ from the memory 58 and then send the control signal SC″ to the LED driver 36′. The LED driver 36′ provides corresponding driving signals SD″ to drive the red, the green, and the blue LEDs based on the control signals SC″. As a result, the color management system of the embodiment can keep the luminance of the LEDs in a LED backlight module and the chromaticity of the backlight substantially constant. Besides, the color management system of this embodiment also has the advantages of less elements number needed, lower producing and element-adjusting cost in comparison to the conventional color management system.

In this embodiment, the red, green, and blue LEDs can be also controlled by different driving signals corresponding to different control signals, which are generated based on different look-up tables. The memory 58 can store three different look-up tables for respectively mapping the time-of-use signal St′ and the temperature signal Se′ to three control signals for controlling the LED driver 36′ to drive the red, the green, and the blue LEDs individually.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An open-loop color management system for a light emitting diode (LED) backlight module of a LCD (Liquid Crystal Display), comprising:
means indicating the operation status of the LED backlight module;
a controller generating a control signal based on the operation status by reference to a look-up table; and
a LED driver driving the LED backlight module based on the control signal, so the chromaticity of the LED backlight module may be substantially constant over time.

2. The open-loop color management system according to claim 1, wherein the indicating means comprises:
a timer generating a time-of-use signal indicating the time of use of the LED backlight module.

3. The open-loop color management system according to claim 2, wherein the look-up table is stored in a memory for mapping the time-of-use signal to the corresponding control signal.

4. The open-loop color management system according to claim 1, wherein the indicating means comprises:
a temperature meter generating a temperature signal indicating the temperature of the LED backlight module.

5. The open-loop color management system according to claim 4, wherein the look-up table is stored in a memory for mapping the temperature signal to the corresponding control signal.

6. The open-loop color management system according to claim 1, wherein the indicating means comprises:
a timer generating a time-of-use signal indicating the time of use of the LED backlight module; and
a temperature meter generating a temperature signal indicating the temperature of the LED backlight module.

7. The open-loop color management system according to claim 6, wherein the look-up table is stored in a memory for mapping the time-of-use signal and the temperature signal to the corresponding control signal.
